(19) United States
(12) Patent Application Publication
(10) Pub. No.: US 2025/0330725 A1
(43) Pub. Date: Oct. 23, 2025

(54) OPTICAL COMPENSATION SYSTEM AND OPTICAL COMPENSATION METHOD

(71) Applicant: Samsung Display Co., LTD., Yongin-si (KR)

(72) Inventors: Yasuhiko SHINKAJI, Yokohama (JP); Yoshiyuki KUROKAWA, Yokohama (JP)

(21) Appl. No.: 19/012,165

(22) Filed: Jan. 7, 2025

(30) Foreign Application Priority Data
Apr. 19, 2024 (KR) 10-2024-0052514

(51) Int. Cl. H04N 25/51; H04N 25/60; H04N 25/78

(52) U.S. Cl. CPC H04N 25/51; H04N 25/60; H04N 25/78

(57) ABSTRACT

An optical compensation system includes an electronic device including an optical sensor, and an optical compensation data generation device that outputs compensation data corresponding to a characteristic of the optical sensor based on a sensing output signal from the optical sensor. The optical compensation data generation device calculates a first offset and a gain based on the sensing output signal, outputs a second offset calculated by deleting the gain while the first offset is calculated based on characteristics of the first offset and the gain, and outputs the second offset as the compensation data. The electronic device performs optical compensation on a readout signal from the optical sensor based on the compensation data from the optical compensation data generation device and outputs a compensated readout signal.

This application claims priority to Korean Patent Application No. 10-2024-0052514, filed on Apr. 19, 2024, and all the benefits accruing therefrom under 35 U.S.C. § 119, the content of which in its entirety is herein incorporated by reference.

### BACKGROUND

### 1. Field

The present invention relates to an optical compensation system, and more particularly to an optical compensation system which includes an electronic device having a built-in optical sensor.

### 2. Description of Related Art

Electronic devices such as a TV, a mobile phone, a tablet personal computer (PC), a navigation system, a game console, and the like may adopt a touch-based input method that allows a user to enter information or commands easily and intuitively, in addition to a general input method such as a button, a keyboard, a mouse, or the like.

Currently, a method using biometric information, such as a fingerprint, has been proposed as a user authentication means for online banking, product purchase, security, or the like. The demand for an electronic device having a fingerprint recognition function is increasing.

An optical sensor used for fingerprint recognition, document scanning, or the like may be provided separately from the display panel of the electronic device.

### SUMMARY

Embodiments of the invention provide an optical compensation system capable of compensating for the characteristics of an optical sensor by using an optical sensor, and an optical compensation method thereof.

According to an embodiment, an optical compensation system includes an electronic device including an optical sensor, and an optical compensation data generation device that outputs compensation data corresponding to a characteristic of the optical sensor based on a sensing output signal from the optical sensor. The optical compensation data generation device calculates a first offset and a gain based on the sensing output signal, outputs a second offset replaced by deleting the gain while the first offset is replaced based on characteristics of the first offset and the gain, and outputs the second offset as the compensation data. The electronic device performs optical compensation on a readout signal from the optical sensor based on the compensation data from the optical compensation data generation device and outputs a compensated readout signal.

In an embodiment, the optical compensation data generation device may include a compensation data calculator that receives the sensing output signal and that outputs the compensation data, an encoder that compresses the compensation data and that outputs the compressed compensation data, and a memory that stores the compressed compensation data.

In an embodiment, a sensing prediction signal OF(j) may be calculated based on Equation 1 given by: OF(j)=GB(j)×ΔIf+j, where j denotes the first offset, GB(j) denotes an average gain of the sensing output signal, and ΔIf denotes incident intensity.

In an embodiment, the encoder may divide the compensation data into a coherent component and an incoherent component, and may individually compress the coherent component and the incoherent component.

In an embodiment, the electronic device may include a first memory that stores the compensation data.

In an embodiment, the optical compensation system includes a decoder that outputs a restored compensation signal by decoding the compensation data stored in the first memory, a second memory that stores the restored compensation signal, and an optical compensation processor that outputs the compensated readout signal corresponding to the readout signal based on the restored compensation signal.

In an embodiment, the electronic device may further include a post-processor that removes noise from the compensated readout signal and that outputs a final readout signal.

In an embodiment, the post-processor may include a denoiser that employs Deep Convolutional Neural Networks (DCNN).

In an embodiment, the electronic device may further include an display panel including a pixel and a sensor, and a readout circuit that outputs a sensing signal from the sensor as at least one of the sensing output signal and the readout signal.

In an embodiment, the optical sensor may include the sensor and the readout circuit.

In an embodiment, when an input image signal of black color is provided to an display panel, the first offset may be a signal level of the sensing output signal.

In an embodiment, the gain Gk may be calculated based on Equation 2 given by: Gk=ΔSk/ΔI, wherein ΔSk is a difference value between the sensing output signal when the input image signal of white color is provided to the display panel and the sensing output signal when the input image signal of black color is provided to the display panel, and ΔI is a difference value between incident intensity corresponding to the input image signal of the white color and incident intensity corresponding to the input image signal of the black color.

According to an embodiment, an optical compensation method includes receiving a sensing output signal from an optical sensor of an electronic device under conditions of a first offset, a gain, and incident intensity, searching for a sensing prediction signal closest to the sensing output signal, and replacing the first offset with an offset corresponding to the sensing prediction signal and outputting a replaced offset as compensation data.

In an embodiment, a sensing prediction signal OF(j) may be calculated based on Equation 1 given by: OF(j)=GB(j)×ΔIf+j, where j denotes the first offset, GB(j) denotes an average gain of the sensing output signal, and ΔIf denotes incident intensity.

In an embodiment, the optical compensation method may further include compressing and outputting the compensation data. The compensation data may be divided into a coherent component and an incoherent component, and the coherent component and the incoherent component may be individually compressed.

In an embodiment, the optical compensation method may further include outputting a compensated readout signal corresponding to a readout signal from the optical sensor based on the compensation data.

In an embodiment, the outputting of the compensated readout signal corresponding to the readout signal may include outputting a restored compensation signal by decoding the compensation data, and outputting the compensated readout signal corresponding to the readout signal based on the restored compensation signal.

In an embodiment, the optical compensation method may further include removing noise from the compensated readout signal and outputting a final readout signal.

In an embodiment, the electronic device may further include an display panel including a pixel and a sensor, and a readout circuit that outputs a sensing signal from the sensor as at least one of the sensing output signal and the readout signal. The optical sensor may include the sensor and the readout circuit.

In an embodiment, when an input image signal of black color is provided to an display panel, the first offset may be a signal level of the sensing output signal.

In an embodiment, the gain Gk may be calculated based on Equation 2 given by: Gk=ΔSk/ΔI, where ΔSk is a difference value between the sensing output signal when the input image signal of white color is provided to the display panel and the sensing output signal when the input image signal of black color is provided to the display panel, and ΔI is a difference value between incident intensity corresponding to the input image signal of the white color and incident intensity corresponding to the input image signal of the black color.

### BRIEF DESCRIPTION OF THE FIGURES

The above and other objects and features of the invention will become apparent by describing in detail embodiments thereof with reference to the accompanying drawings.

FIG. 1 is a schematic block diagram of an optical compensation device and an electronic device, according to an embodiment.

FIG. 2 is a schematic block diagram of an optical compensation system, according to an embodiment the present disclosure.

FIG. 3 is a diagram for describing an operation of an optical compensation system shown in FIG. 2, according to an embodiment.

FIG. 4 is a graph illustrating sensitivity characteristics of some of sensors also shown in FIG. 1, according to an embodiment.

FIG. 5 is a graph for describing an operation of a compensation data calculator, according to an embodiment.

FIG. 6 shows a graph and a histogram of intensity detected by some of sensors, according to an embodiment.

FIG. 7 are graphs illustrating a method for calculating a sensing prediction signal in a compensation data calculator, according to an embodiment.

FIG. 8 is a table illustrating offsets, an average gain, and a sensing prediction signal, according to an embodiment.

FIG. 9 is a flowchart showing an operation of a compensation data calculator, according to an embodiment.

FIG. 10 is a diagram and graphs illustrating a compression operation of an encoder, according to an embodiment.

FIG. 11 is a diagram illustrating a post-processor, according to an embodiment.

FIG. 12A is an optical image showing a compensated readout signal output from an optical compensation processor as an image, according to an embodiment.

FIG. 12B is an optical image showing a compensated readout signal output from an optical compensation processor as an image, according to an embodiment.

FIG. 12C is an optical image illustrating a final readout signal output from a post-processor, according to an embodiment.

FIG. 13 is a block diagram of an optical compensation system, according to an embodiment.

### DETAILED DESCRIPTION

In the specification, the expression that a first component (or region, layer, part, etc.) is “on”, “connected with”, or “coupled with” a second component means that the first component is directly on, connected with, or coupled with the second component or means that a third component is interposed therebetween.

Moreover, the same sign refers to the same element. Also, in drawings, the thickness, ratio, and dimension of components are exaggerated for effectiveness of description of technical contents. The term “and/or” includes one or more combinations of the associated listed items.

Although the terms “first”, “second”, etc. may be used to describe various components, the components should not be construed as being limited by the terms. The terms are only used to distinguish one component from another component. For example, without departing from the scope and spirit of the invention, a first component may be referred to as a second component, and similarly, the second component may be referred to as the first component. The articles “a,” “an,” and “the” are singular in that they have a single referent, but the use of the singular form in the specification should not preclude the presence of more than one referent.

Also, the terms “under”, “beneath”, “on”, “above”, etc. are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in this specification have the same meaning as commonly understood by those skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the invention will be described with reference to accompanying drawings.

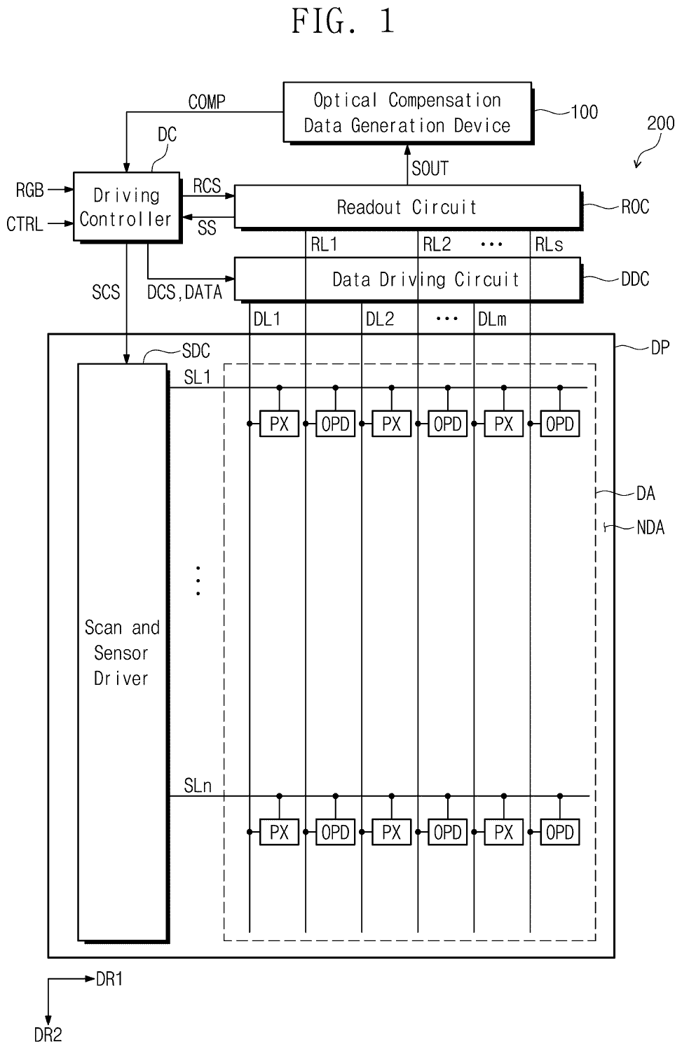

FIG. 1 is a schematic block diagram of an optical compensation device and an electronic device, according to an embodiment.

In an embodiment and referring to FIG. 1, an electronic device 200 includes a display panel DP, a driving controller DC, a data driving circuit DDC, a scan and sensor driver SDC and a readout circuit ROC.

In an embodiment, the driving controller DC receives an input image signal RGB and a control signal CTRL and generates an output image signal DATA by converting a data format of the input image signal RGB so as to be suitable for the display panel DP and the data driving circuit DDC. The driving controller DC outputs a scan control signal SCS, a data control signal DCS, and a readout control signal RCS.

In an embodiment, the data driving circuit DDC receives the data control signal DCS and the output image signal DATA from the driving controller DC. The data driving circuit DDC converts the output image signal DATA into data signals and then outputs the data signals to a plurality of data lines DL1, DL2, . . . , DLm to be described later. The data signals refer to analog voltages corresponding to a grayscale level of the output image signal DATA.

In an embodiment, the display panel DP includes scan lines SL1 to SLn, data lines DL1 to DLm, readout lines RL1 to RLs, pixels PX, and sensors OPD.

The display panel DP may include a display area DA and a non-display area NDA, where the pixels PX and the sensors OPD may be disposed in the display area DA. The scan and sensor driver SDC may be disposed in the non-display area NDA of the display panel DP.

In an embodiment, the scan and sensor driver SDC may be disposed adjacent to a first side of the display area DA in the display panel DP. The scan and sensor driver SDC receives the scan control signal SCS from the driving controller DC. The scan and sensor driver SDC outputs scan signals to the scan lines SL1 to SLn in response to the scan control signal SCS. The scan lines SL1 to SLn extend from the scan and sensor driver SDC in a first direction DR1 and are arranged to be spaced apart from each other in a second direction DR2. The data lines DL1 to DLm extend from the data driving circuit DDC in the second direction DR2 and are arranged to be spaced apart from one another in the first direction DR1.

In an embodiment, the plurality of pixels PX are electrically connected to the scan lines SL1 to SLn and the data lines DL1 to DLm. FIG. 1 shows that the one pixel PX is connected to one of the scan lines SL1 to SLn, but the invention is not limited thereto. For example, in an embodiment, the one pixel PX may be connected to a plurality of scan lines among the scan lines SL1 to SLn.

In an embodiment, the plurality of sensors OPD are electrically connected to the scan lines SL1 to SLn and the readout lines RL1 to RLs. The plurality of sensors OPD may be formed through the same process as the plurality of pixels PX. The number of sensors OPD may be the same as or different from the number of pixels PX.

In an embodiment, the readout circuit ROC receives the readout control signal RCS. The readout circuit ROC receives sensing signals from the readout lines RL1 to RLs in response to the readout control signal RCS. In a sensing mode, the readout circuit ROC may convert the sensing signals received from the readout lines RL1 to RLs into a readout signal SS and may provide the readout signal SS to the driving controller DC. In an embodiment, the readout signal SS may be a biometric sensing signal including biometric information such as the user's fingerprint, or a document scan signal.

In an embodiment, the sensors OPD and the readout circuit ROC may operate in a compensation mode for detecting the characteristics of the pixels PX and the sensors OPD.

In an embodiment, in the compensation mode, the readout circuit ROC may convert the sensing signals received from the readout lines RL1 to RLs into a sensing output signal SOUT and provide the sensing output signal SOUT to an optical compensation data generation device 100.

In an embodiment, the optical compensation data generation device 100 determines the characteristics of the pixels PX based on the sensing output signal SOUT from the readout circuit ROC and may provide a compensation signal COMP to the driving controller DC.

In an embodiment, the driving controller DC may receive the input image signal RGB and may output the output image signal DATA obtained by compensating for the characteristic deterioration of the pixels PX based on the compensation signal COMP.

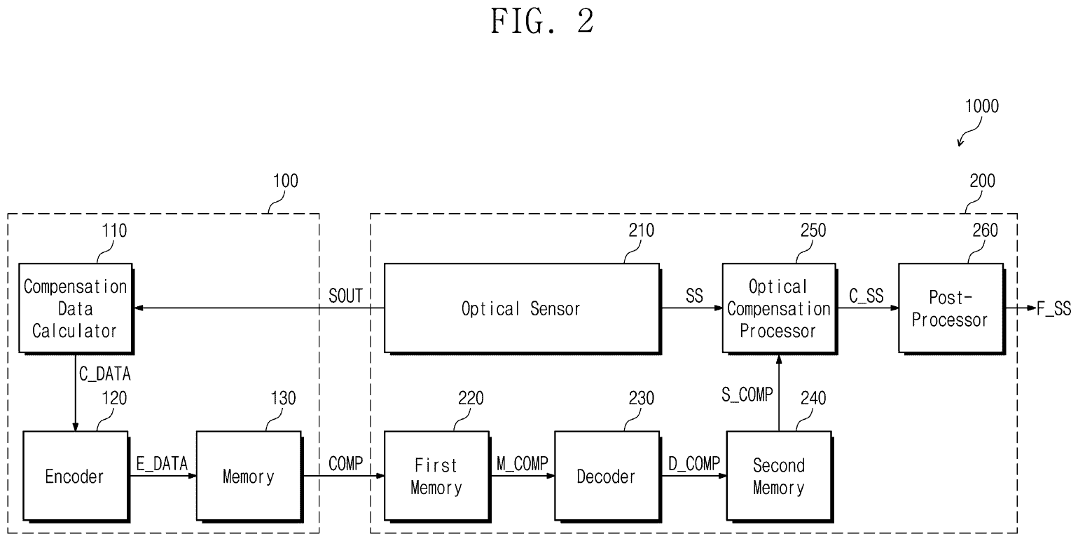

FIG. 2 is a block diagram of an optical compensation system 1000, according to an embodiment.

In an embodiment and referring to FIG. 2, the optical compensation system 1000 includes the optical compensation data generation device 100 and the electronic device 200.

In an embodiment, the optical compensation data generation device 100 includes a compensation data calculator 110, an encoder 120, and a memory 130.

In an embodiment, the electronic device 200 includes an optical sensor 210, a first memory 220, a decoder 230, a second memory 240, an optical compensation processor 250, and a post-processor 260.

In an embodiment, the optical sensor 210 may include the sensors OPD and the readout circuit ROC shown in FIG. 1.

In an embodiment, the first memory 220, the decoder 230, the second memory 240, the optical compensation processor 250, and the post-processor 260 may be included in the driving controller DC shown in FIG. 1.

In an embodiment, the compensation data calculator 110 of the optical compensation data generation device 100 calculates compensation data C_DATA corresponding to the characteristics of the optical sensor 210 based on the sensing output signal SOUT from the optical sensor 210. In detail, the compensation data calculator 110 of the optical compensation data generation device 100 may output the compensation data C_DATA corresponding to the characteristics of the sensors OPD (see FIG. 1) within the optical sensor 210 based on the sensing output signal SOUT from the optical sensor 210.

In an embodiment, the encoder 120 compresses the compensation data C_DATA and outputs compressed compensation data E_DATA.

In an embodiment, the memory 130 stores the compressed compensation data E_DATA output from the encoder 120. In an embodiment, the memory 130 may be a volatile memory (e.g., a dynamic random access memory (DRAM)).

In an embodiment, the compressed compensation data E_DATA stored in the memory 130 may be provided to the electronic device 200 as a compensation signal COMP.

According to an embodiment, at a step of manufacturing the electronic device 200, the optical characteristics of the electronic device 200 may be inspected, and the compressed compensation data E_DATA corresponding to the optical characteristics of the electronic device 200 may be stored in the memory 130.

Moreover, at the step of manufacturing the electronic device 200, the compensation signal COMP stored in the memory 130 of the optical compensation data generation device 100 may be transmitted to the first memory 220 of the electronic device 200.

In an embodiment, the first memory 220 of the electronic device 200 stores the compensation signal COMP from the optical compensation data generation device 100. In an embodiment, the first memory 220 may be a non-volatile memory (e.g., electrically erasable programmable read-only memory (EEPROM)).

In an embodiment, the decoder 230 decodes a compensation signal M_COMP stored in the first memory 220. In other words, the decoder 230 may restore compensation data compressed by the encoder 120 of the optical compensation data generation device 100. A compensation signal D_COMP restored by the decoder 230 may be stored in the second memory 240. In an embodiment, the second memory 240 may be a static random access memory (SRAM).

In an embodiment, the optical compensation processor 250 compensates for the readout signal SS based on a compensation signal S_COMP from the second memory 240 and outputs the compensated readout signal C_SS.

In an embodiment, the post-processor 260 removes noise from the compensated readout signal C_SS and outputs a final readout signal F_SS.

As the production technology of the display panel DP shown in FIG. 1 has recently improved, the number of pixels PX and the number of sensors OPD per unit area of the display panel DP are increasing. In other words, the resolution of the display panel DP is increasing. As the resolution of the display panel DP increases, the size of the sensing output signal SOUT output from the optical sensor 210 also increases. When the size of the sensing output signal SOUT increases, the size of the memory 130 of the optical compensation data generation device 100, the size of each of the first memory 220 and the second memory 240 of the electronic device 200 need to be increased. This may increase the production cost of the electronic device 200.

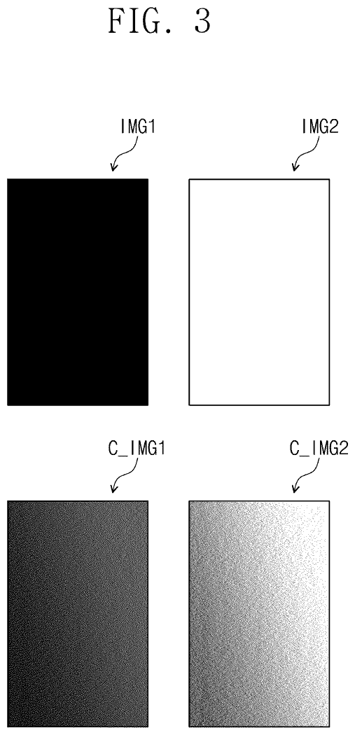

FIG. 3 is a diagram for describing an operation of the optical compensation system 1000 shown in FIG. 2, according to an embodiment.

In an embodiment and referring to FIGS. 2 and 3, to test the electronic device 200, the input image signal RGB corresponding to a black image IMG1 and the input image signal RGB corresponding to a white image IMG2 are sequentially provided to the electronic device 200.

When the input image signal RGB corresponding to the black image IMG1 is provided to the electronic device 200, the first captured image C_IMG1 was obtained by displaying the sensing output signal SOUT output from the optical sensor 210 as an image.

When the input image signal RGB corresponding to the white image IMG2 is provided to the electronic device 200, the second captured image C_IMG2 was obtained by displaying the sensing output signal SOUT output from the optical sensor 210 as an image.

In an embodiment, even though the black image IMG1 in completely black color is provided with the electronic device 200, the first captured image C_IMG1 may not completely have black color depending on the production quality of the pixels PX (see FIG. 1) and the sensors OPD (see FIG. 1).

In an embodiment, even though the white image IMG2 in completely white color is provided with the electronic device 200, the second captured image C_IMG2 may not completely have white color depending on the production quality of the pixels PX (see FIG. 1) and the sensors OPD (see FIG. 1).

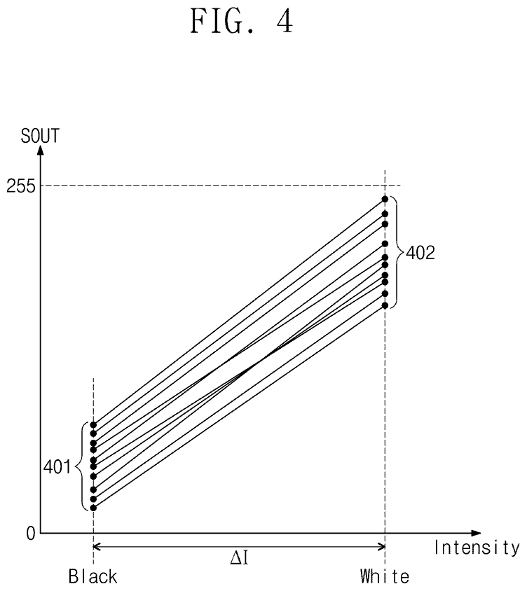

FIG. 4 is a graph illustrating sensitivity characteristics of some of the sensors OPD also shown in FIG. 1, according to an embodiment.

In an embodiment, when the input image signal RGB (e.g., the black image IMG1 shown in FIG. 3) of black color is provided to the electronic device 200, first sensing output signals 401 shown in FIG. 4 corresponds to the intensity detected by the 10 arbitrary sensors OPD among the plurality of sensors OPD of the display panel DP.

In an embodiment, when the input image signal RGB (e.g., the white image IMG2 shown in FIG. 3) of white color is provided to the electronic device 200, second sensing output signals 402 shown in FIG. 4 corresponds to the intensity detected by the 10 arbitrary sensors OPD among the plurality of sensors OPD of the display panel DP.

In FIG. 4, a deviation ΔI refers to a difference between the incident intensity corresponding to the input image signal RGB of white color and the incident intensity of the input image signal RGB of black color. In FIG. 4, the first sensing output signals 401 and the second sensing output signals 402 are shown as straight lines, but the invention is not limited thereto. When the sensing characteristics of the sensors OPD according to the intensity of the pixels PX (see FIG. 1) are converted/replaced to be linear, the first sensing output signals 401 and the second sensing output signals 402 output from the sensors OPD may be connected to each other as straight lines.

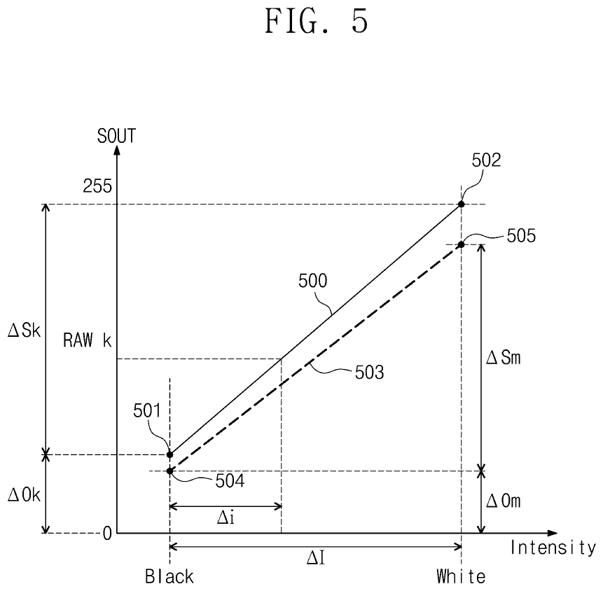

FIG. 5 is a graph for describing an operation of the compensation data calculator 110, according to an invention.

In an embodiment and referring to FIGS. 1, 2, and 5, the compensation data calculator 110 calculates a gain Gk for a sensitivity characteristic 500 of any sensor OPD among the plurality of sensors OPD shown in FIG. 1.

In the embodiment shown in FIG. 5, a first sensing output signal 501 for the input image signal RGB of black color is expressed as a first offset ΔOk. A difference between a second sensing output signal 502 and the first sensing output signal 501 for the input image signal RGB of white color is expressed as a second offset ΔSk.

In an embodiment, an average sensitivity characteristic 503 is obtained by connecting an average value 504 of the first sensing output signals 401 shown in FIG. 4 to an average value 505 of the second sensing output signals 402 shown in FIG. 4 with a straight line.

The average value 504 of the first sensing output signals 401 is expressed as a third offset ΔOm. Moreover, a difference between the average value 504 of the first sensing output signals 401 and the average value 505 of the second sensing output signals 402 is expressed as a fourth offset ΔSm.

In an embodiment, the compensation data calculator 110 compensates for the sensitivity characteristic 500 of the arbitrary sensor OPD based on the average sensitivity characteristic 503.

The gain Gk for the sensitivity characteristic 500 of the arbitrary sensor OPD (i.e., the k-th sensor OPD) and a gain Gm for the average sensitivity characteristic 503 may be calculated based on Equation 1 (k is a positive integer), as follows:

$$Gk = Δ Sk / Δ I , \qquad [ Equation 1 ]$$

$$Gm = Δ Sm / Δ I ,$$

where the incident intensity is Δi and the luminance RAW k(i) of the arbitrary sensor OPD is given in Equation 2, as follows:

$$RAW k ( i ) = Gk \times Δ i + Δ Ok , \qquad [ Equation 2 ] .$$

In an embodiment, the compensation data calculator 110 optically compensates for the luminance of the arbitrary sensor OPD. Optical compensation luminance CAL k(i) calculated by the compensation data calculator 110 is given in Equation 3 as follows:

$$CAL k ( i ) = ( Gm / Gk ) \times ( RAW k ( i ) - Δ Ok ) + Δ Om , \qquad [ Equation 3 ] .$$

In an embodiment, the compensation data calculator 110 may perform optical compensation processing on all the sensors OPD.

When the number of all the sensors OPD is ‘Q’ (where ‘Q’ is a positive integer), the number of the first offset ΔOk is ‘Q’, and the number of the gain Gk of the sensitivity characteristic 500 of the arbitrary sensor OPD is also required to be ‘Q’.

In an embodiment, the compensation data calculator 110 may reduce either the first offset ΔOk and the gain Gk based on the characteristics of the first offset ΔOk and the gain Gk.

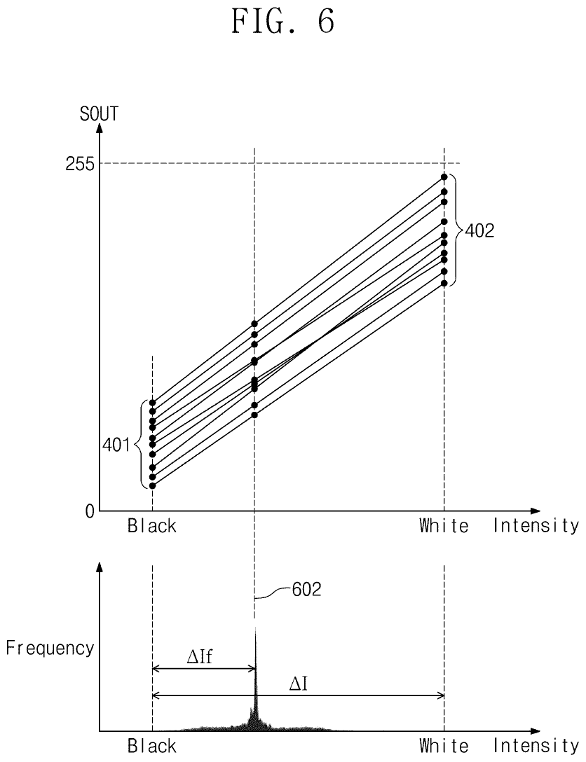

FIG. 6 shows a histogram of intensity detected by some of the sensors OPD, according to an embodiment.

In an embodiment and referring to FIG. 6, the first sensing output signals 401 and the second sensing output signals 402 are the same as those shown in FIG. 4, and thus and additional descriptions are omitted to avoid redundancy.

According to an embodiment, in a sensing mode, the sensors OPD may detect a user's fingerprint or may scan a document. At this time, the part of the display panel DP, which is in contact with the user's finger or paper, becomes a closed space, and thus it is relatively less affected by external light. Accordingly, the optical characteristics are stable.

In the embodiment shown in FIG. 6, impulse 602 indicates a location where light reflected from the user's finger is concentrated when the reflected light is incident on the sensors OPD. This intensity is called incident intensity ΔIf.

When optical compensation is sufficiently precisely performed on a portion around the incident intensity ΔIf, the imaging performance of the sensors OPD may be improved.

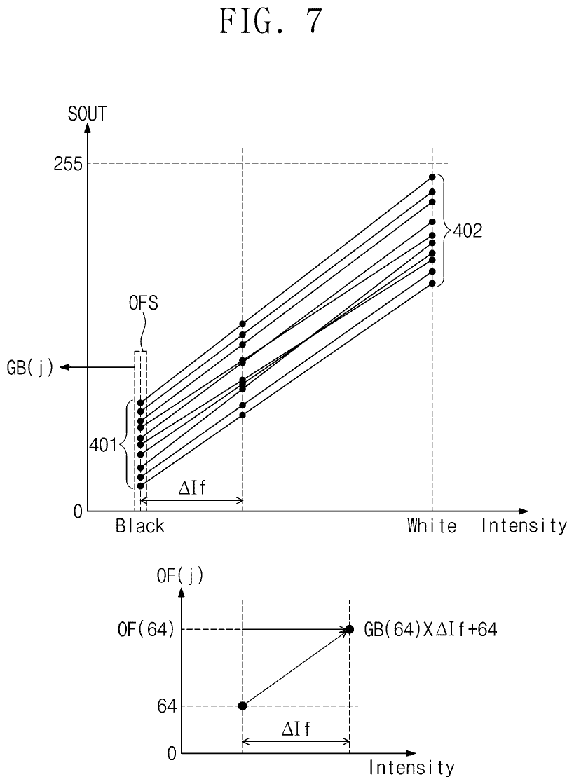

FIG. 7 is a diagram illustrating a method for calculating a sensing prediction signal OF(j) in the compensation data calculator 110, according to an embodiment.

In an embodiment and referring to FIGS. 2 and 7, the compensation data calculator 110 calculates an average gain GB(j) (where j is a real number from 0 to 255) of each of the offsets OFS for the first sensing output signals 401 of the sensors OPD. The compensation data calculator 110 calculates the sensing prediction signal OF(j) (where j is a real number from 0 to 255) at the incident intensity ΔIf based on the average gain GB(j) as shown in Equation 4 as follows:

$$OF ( j ) = GB ( j ) \times Δ If + j , \qquad [ Equation 4 ] .$$

For example, assuming that the average gain of the sensors OPD having the offset OFS of 64 (j=64) is GB(64), the sensing prediction signal OF(64) is given as follows: OF(64)=GB(64)×ΔIf+64.

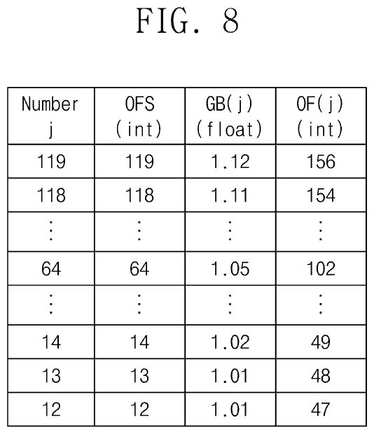

FIG. 8 is a table illustrating the offsets OFS, the average gain GB(j), and the sensing prediction signal OF(j), according to an embodiment.

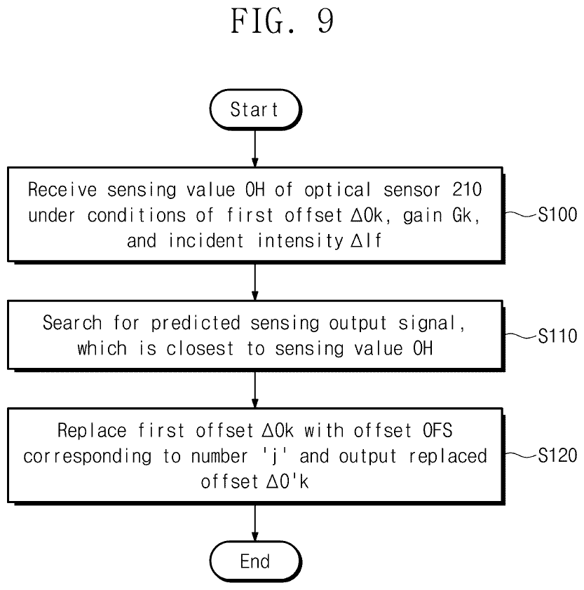

FIG. 9 is a flowchart showing an operation of a compensation data calculator, according to an embodiment.

In an embodiment and referring to FIGS. 2, 7, 8, and 9, the compensation data calculator 110 may calculate a compensation value for optical compensation in the following order.

The compensation data calculator 110 receives the sensing output signal SOUT from the optical sensor 210 under conditions of the first offset ΔOk (see FIG. 5), the gain Gk (k=0, 1, . . . , N−1), and the incident intensity ΔIf (operation S100). Here, the sensing output signal SOUT is referred to as a “sensing value OH”. The compensation data calculator 110 may calculate the first offset ΔOk, the gain Gk, and the incident intensity ΔIf based on the sensing output signal SOUT from the optical sensor 210.

The compensation data calculator 110 obtains number j by searching for the sensing prediction signal OF(j), which is closest to the sensing value OH. In FIG. 8, j is 12, 13, 14, . . . , 118, 119 (operation S110). In other words, the compensation data calculator 110 searches for j where |OF(j)−OH| is a minimum.

The compensation data calculator 110 replaces the first offset ΔOk with the offset OFS corresponding to number j and outputs the replaced offset (referred to as ΔO′k) (operation S120).

In other words, the compensation data calculator 110 replaces the first offset ΔOk with the offset OFS corresponding to the sensing prediction signal OF(j) that is closest to the sensing value OH and outputs the replaced offset (referred to as ΔO′k).

In an embodiment, the compensation data calculator 110 repeatedly performs operations S100, S110, and S120 on all the sensors OPD. The optical compensation in this replacement process requires the replaced offset ΔO′k and the offset-specific average gain GB(j). In the example shown in FIG. 8, a real number array having the length of 108 needs to be prepared for the offset-specific average gain GB(j). This case may correspond to approximately half the size of the entire compensation data. Furthermore, when the incident intensity is ΔIf, the sensing value OH of the optical sensor 210 is almost similar to the output calculated by the first offset ΔOk and the gain Gk (see FIG. 5). Accordingly, even in the case of optical compensation by the replaced offset ΔO′k and the gain GB(j), the image quality of a subject is expected to be secured.

When the incident intensity is Δi, the optical compensation CAL k(i) for the arbitrary sensor OPD among the sensors OPD is as shown in Equation 5 as follows:

$$CAL k ( i ) = ( Gm / GB ( Δ {O}^{′} k ) ) \times ( RAW k ( i ) - Δ {O}^{′} k ) + Δ Om , \qquad [ Equation 5 ] .$$

In an embodiment, the compensation data calculator 110 outputs the replaced offset ΔO′k as the compensation data C_DATA.

Accordingly, the size of the compensation data C_DATA generated by the compensation data calculator 110 may be reduced.

In an embodiment, the compensation data C_DATA may be further compressed by the encoder 120.

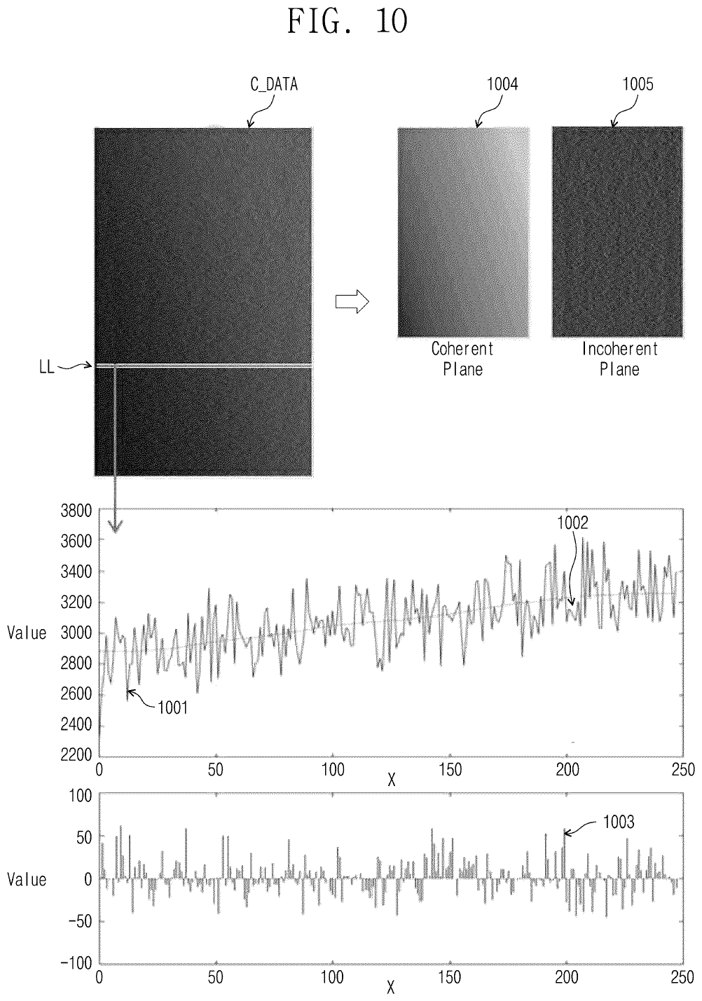

FIG. 10 is a diagram illustrating a compression operation of the encoder 120, according to an embodiment.

In an embodiment and referring to FIGS. 2 and 10, the compensation data C_DATA may include a coherent component and an incoherent component.

In FIG. 10, the compensation data C_DATA is shown as a two-dimensional plane. When 1 line LL of the compensation data C_DATA is extracted, line data 1001 may be extracted.

In the example shown in FIG. 10, the line data 1001 is random data that increases as it moves towards the right. When an incoherent component is removed by smoothing the line data 1001, a coherent component 1002 may be obtained. Moreover, when the coherent component 1002 is subtracted from the line data 1001, an incoherent component 1003 may be obtained.

In an embodiment, as a result, the compensation data C_DATA may be separated into a coherent plane 1004 and an incoherent plane 1005. When the coherent component 1002 and the incoherent component 1003 are compressed individually, the size of the compensation data C_DATA may be further reduced. Here, for example, Huffman coding or range coding may be used as a codec used for compression. The compressed compensation data E_DATA may be stored in the memory 130. In an embodiment, the average gain GB(j) calculated by the compensation data calculator 110 may also be stored in the memory 130. Also, the average gain GB(j) stored in the memory 130 may be loaded into the first memory 220 of the electronic device 200.

In an embodiment, in a sensing mode, the optical sensor 210 of the electronic device 200 scans biometric information such as a user's fingerprint, or documents. The readout signal SS output from the optical sensor 210 may be provided to the optical compensation processor 250.

In an embodiment, in the sensing mode, the compensation signal M_COMP stored in the first memory 220 is provided to the decoder 230.

The decoder 230 decodes the compensation signal M_COMP and outputs the restored compensation signal D_COMP. The restored compensation signal D_COMP is stored in the second memory 240.

In an embodiment, the optical compensation processor 250 compensates for the readout signal SS based on a compensation signal S_COMP from the second memory 240 and outputs the compensated readout signal C_SS.

In an embodiment, the optical compensation processor 250 may execute the operation of Equation 5 and may output the compensated readout signal C_SS corresponding to the readout signal SS.

In other words, when the incident intensity indicated by the readout signal SS is Δi, the optical compensation processor 250 may output the readout signal C_SS compensated by the calculation method of Equation 3.

In an embodiment, in a process in which the optical compensation data generation device 100 calculates the compensation signal COMP, gain information is reduced by using only offset information as compensation data, and thus the compensation signal COMP may include an error.

In an embodiment, in a process of reducing compensation data, the characteristics of the incident intensity ΔIf are used as a reference, and thus this may differ from original optical characteristics. In particular, the characteristics (i.e., image quality) of the sensor (OPD) whose incident intensity is close to ΔIf are maintained, but errors of the sensor OPD whose incident intensity is far from ΔIf are increased. The errors may be included as noise in the compensated readout signal C_SS output from the optical compensation processor 250.

In an embodiment, the post-processor 260 removes noise from the compensated readout signal C_SS and outputs the final readout signal F_SS.

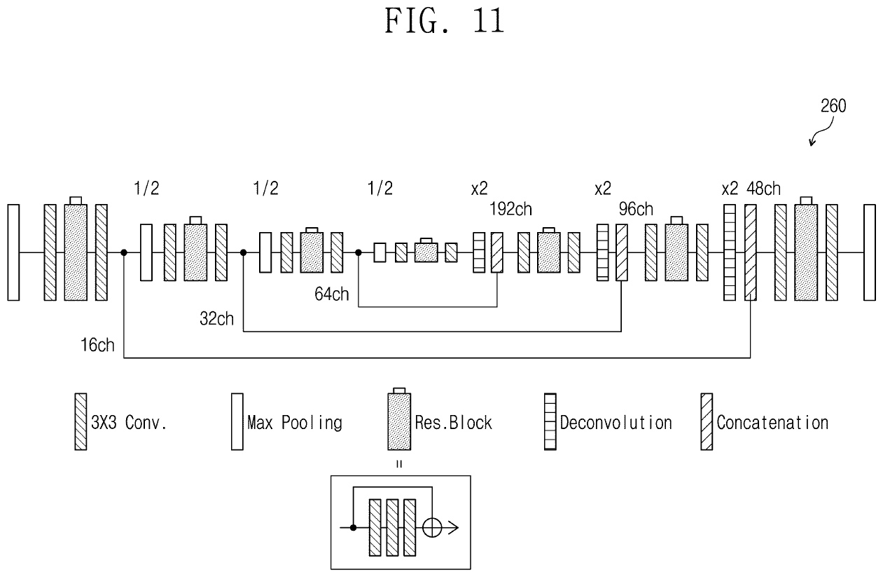

FIG. 11 is a diagram illustrating the post-processor 260, according to an embodiment.

In an embodiment and referring to FIG. 11, the post-processor 260 may be a denoiser employing deep convolutional neural networks (DCNN).

In an embodiment, the weight of the DCNN may be trained in the following two manners.

Training using optical compensation results as input data when gain information is reduced by using only an offset as compensation data.

Training optical compensation results by the compensation data including offset information and gain information as ground-truth data.

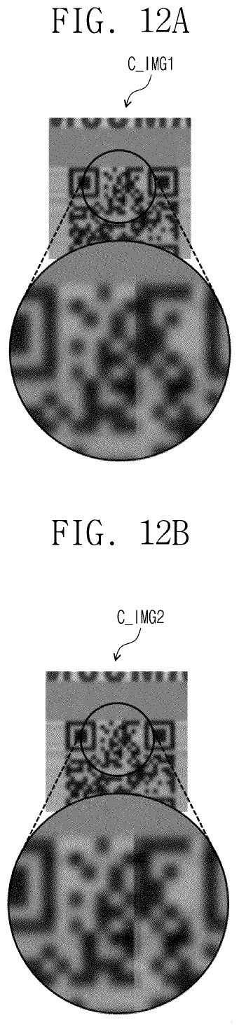

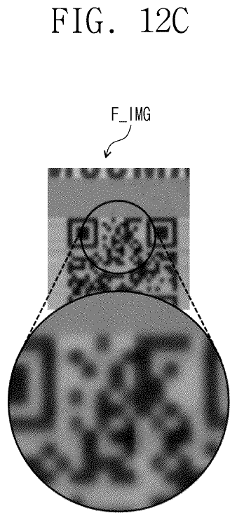

FIGS. 12A and 12B are diagrams showing the compensated readout signal C_SS output from the optical compensation processor 250 as an image, according to an embodiment.

In an embodiment, a first captured image C_IMG1 illustrated in FIG. 12A is obtained as an image by using the compensated readout signal C_SS output from the optical compensation processor 250 when optical compensation is performed on the readout signal SS based on offset information and gain information generated by the compensation data calculator 110.

In an embodiment, a second captured image C_IMG2 shown in FIG. 12B is obtained as an image by using the compensated readout signal C_SS output from the optical compensation processor 250 when the gain information is reduced by using only an offset as the compensation data generated by the compensation data calculator 110.

FIG. 12C is an image illustrating the final readout signal F_SS output from the post-processor 260, according to an embodiment.

In an embodiment, a third image F_IMG shown in FIG. 12C is obtained as an image by using the final readout signal F_SS output from the post-processor 260.

Comparing FIGS. 12A, 12B, and 12C, it may be seen that noise is removed by a denoising operation of the post-processor 260.

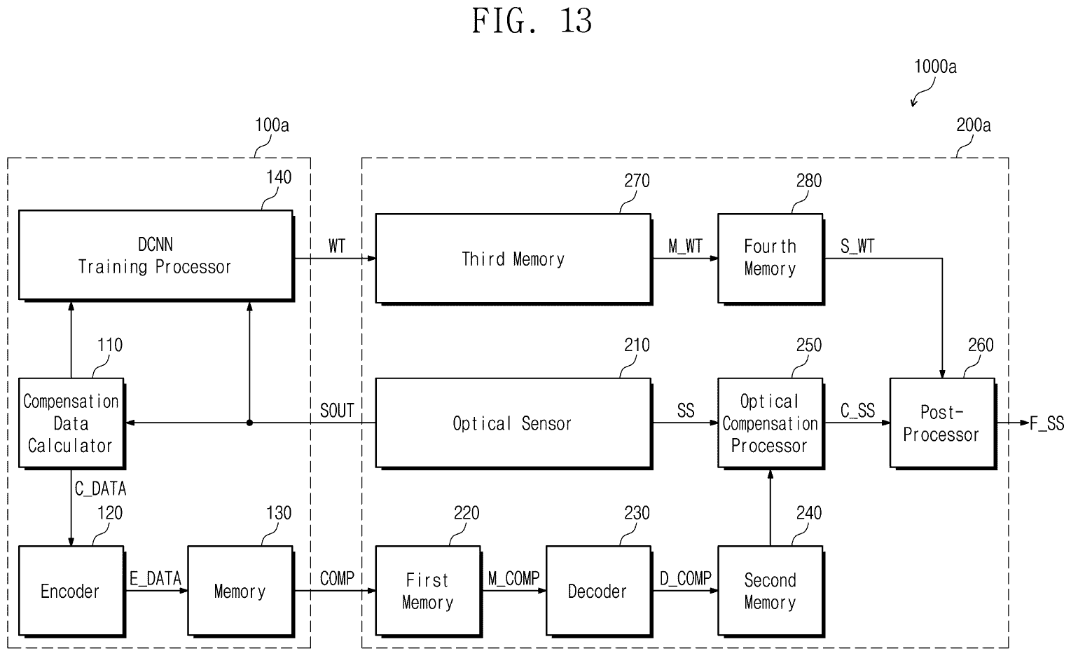

FIG. 13 is a block diagram of an optical compensation system 1000a, according to an embodiment of the present disclosure, according to an embodiment.

In an embodiment and referring to FIG. 13, an optical compensation data generation device 100a includes the compensation data calculator 110, the encoder 120, the memory 130, and a DCNN training processor 140.

The compensation data calculator 110, the encoder 120, and the memory 130 are the same as those shown in FIG. 2. Accordingly, the same reference numerals are used for the same components, and additional descriptions are omitted to avoid redundancy.

The DCNN training processor 140 trains a weight of the DCNN based on information provided by the sensing output signal SOUT and the compensation data calculator 110 in a step of manufacturing the electronic device 200.

The information provided from the compensation data calculator 110 to the DCNN training processor 140 may include offset information, gain information, and the compensation data C_DATA.

In an embodiment, the electronic device 200a includes the optical sensor 210, the first memory 220, the decoder 230, the second memory 240, the optical compensation processor 250, the post-processor 260, a third memory 270, and a fourth memory 280.

The first memory 220, the decoder 230, the second memory 240, the optical compensation processor 250, and the post-processor 260 are similar to those shown in FIG. 2. Accordingly, the same reference numerals are used for the same components, and additional descriptions are omitted to avoid redundancy.

In an embodiment, the third memory 270 may be a non-volatile memory (e.g., an electrically erasable programmable read-only memory (EEPROM)).

In an embodiment, the fourth memory 280 may be a static random access memory (SRAM).

In an embodiment, a weight WT provided from the DCNN training processor 140 in a step of manufacturing the electronic device 200 may be stored in the third memory 270. When the electronic device 200a is operating, a weight M_WT stored in the third memory 270 may be stored in the fourth memory 280. The post-processor 260 removes noise from the compensated readout signal C_SS with reference to a weight S_WT stored in the fourth memory 280 and outputs the final readout signal F_SS.

Although an embodiment of the invention has been described for illustrative purposes, those skilled in the art will appreciate that various modifications, and substitutions are possible, without departing from the scope and spirit of the invention. Accordingly, the technical scope of the invention is not limited to the detailed description of this specification.

In an embodiment, an optical compensation system with this configuration may measure the optical characteristics of an optical sensor in advance and may compensate for the sensitivity of the optical sensor depending on the measured results.

In particular, according to an embodiment of the invention, compensation data may be significantly reduced, and thus the production cost of an electronic device may be reduced.

invention. In the above, description has been made with reference to preferred embodiments of the invention, but those skilled in the art or those of ordinary skill in the relevant technical field may understand that various modifications and changes may be made to the invention within the scope while not departing from the spirit and the technology scope of the invention. In addition, embodiments disclosed are not intended to limit the technical spirit of the invention, and all technical ideas disclosed herein should be construed as being included in the scope of the invention. Moreover, embodiments or parts of the embodiments may be combined in whole or in part without departing from the scope of the invention.

What is claimed is:

1. An optical compensation system comprising:
an electronic device including an optical sensor; and
an optical compensation data generation device configured to output compensation data corresponding to a characteristic of the optical sensor based on a sensing output signal from the optical sensor,
wherein the optical compensation data generation device is configured to:
calculate a first offset and a gain based on the sensing output signal;
output a second offset calculated by deleting the gain while the first offset is calculated based on characteristics of the first offset and the gain; and
output the second offset as the compensation data,
wherein the electronic device performs optical compensation on a readout signal from the optical sensor based on the compensation data from the optical compensation data generation device, and outputs a compensated readout signal.

2. The optical compensation system of claim 1, wherein the optical compensation data generation device includes:
a compensation data calculator configured to receive the sensing output signal and to output the compensation data;
an encoder configured to compress the compensation data and to output the compressed compensation data; and
a memory configured to store the compressed compensation data.

3. The optical compensation system of claim 2, wherein a sensing prediction signal OF(j) is calculated based on
$$OF ( j ) = GB ( j ) \times Δ If + j , \qquad ( Equation 1 ) ,$$
where j denotes the first offset, GB(j) denotes an average gain of the sensing output signal, and ΔIf denotes incident intensity, and
wherein the optical compensation data generation device is configured to output the compensation data by correcting the first offset to an offset corresponding to the sensing prediction signal.

4. The optical compensation system of claim 2, wherein the encoder divides the compensation data into a coherent component and an incoherent component, and individually compresses the coherent component and the incoherent component.

5. The optical compensation system of claim 1, wherein the electronic device includes:
a first memory configured to store the compensation data;
a decoder configured to output a restored compensation signal by decoding the compensation data stored in the first memory;
a second memory configured to store the restored compensation signal; and
an optical compensation processor configured to output the compensated readout signal corresponding to the readout signal based on the restored compensation signal.

6. The optical compensation system of claim 4, wherein the electronic device further includes:
a post-processor configured to remove noise from the compensated readout signal and to output a final readout signal,
wherein the post-processor includes a denoiser that employs Deep Convolutional Neural Networks (DCNN).

7. The optical compensation system of claim 1, wherein the electronic device further includes:
a display panel including a pixel and a sensor; and
a readout circuit configured to output a sensing signal from the sensor as at least one of the sensing output signal and the readout signal.

8. The optical compensation system of claim 7, wherein the optical sensor includes the sensor and the readout circuit.

9. The optical compensation system of claim 7, wherein when an input image signal of black color is provided to a display panel, the first offset is a signal level of the sensing output signal.

10. The optical compensation system of claim 9, wherein the gain Gk is calculated based on:
$$Gk = Δ Sk / Δ I , \qquad ( Equation 2 ) ,$$
where ΔSk is a difference value between the sensing output signal when the input image signal of white color is provided to the display panel and the sensing output signal when the input image signal of black color is provided to the display panel, and
where ΔI is a difference value between incident intensity corresponding to the input image signal of the white color and incident intensity corresponding to the input image signal of the black color.

11. An optical compensation method, the method comprising:
receiving a sensing output signal from an optical sensor of an electronic device under conditions of a first offset, a gain, and incident intensity;
searching for a sensing prediction signal which is closest to sensing value of the sensing output signal; and
replacing the first offset with an offset corresponding to the sensing prediction signal and outputting a replaced offset as compensation data.

12. The method of claim 11, wherein the sensing prediction signal OF(j) is calculated based on:
$$OF ( j ) = GB ( j ) \times Δ If + j , \qquad ( Equation 1 ) ,$$
where j denotes the first offset, GB(j) denotes an average gain of the sensing output signal, and ΔIf denotes the incident intensity.

13. The method of claim 12, further comprising:
compressing and outputting the compensation data,
wherein the compensation data is divided into a coherent component and an incoherent component, and wherein the coherent component and the incoherent component are individually compressed.

14. The method of claim 13, further comprising:
outputting a compensated readout signal corresponding to a readout signal from the optical sensor based on the compensation data.

15. The method of claim 14, wherein the outputting of the compensated readout signal corresponding to the readout signal includes:
outputting a restored compensation signal by decoding the compensation data; and
outputting the compensated readout signal corresponding to the readout signal based on the restored compensation signal.

16. The method of claim 15, further comprising:
removing noise from the compensated readout signal and outputting a final readout signal.

17. The method of claim 14, wherein the electronic device further includes:
a display panel including a pixel and a sensor; and
a readout circuit configured to output a sensing signal from the sensor as at least one of the sensing output signal and the readout signal,
wherein the optical sensor includes the sensor and the readout circuit.

18. The method of claim 11, wherein when an input image signal of black color is provided to a display panel, the first offset is a signal level of the sensing output signal.

19. The method of claim 18, wherein the gain Gk is calculated based on:
$$Gk = Δ Sk / Δ I , \qquad ( Equation 2 ) ,$$
where ΔSk is a difference value between the sensing output signal when the input image signal of white color is provided to the display panel and the sensing output signal when the input image signal of black color is provided to the display panel, and
where ΔI is a difference value between incident intensity corresponding to the input image signal of the white color and incident intensity corresponding to the input image signal of the black color.

20. The method of claim 11, further comprising:
receiving the sensing output signal;
compressing the compensation data;
outputting the compressed compensation data; and
storing the compressed compensation data in a memory configured to store the compressed compensation data.
